(19) United States
(12) Patent Application Publication
(10) Pub. No.: US 2006/0190278 A1
(43) Pub. Date: Aug. 24, 2006

(54) Online real estate transaction system

(75) Inventors: Ronald B. Zimmerman, Cincinnati, OH (US); Jack A. Donenfeld, Cincinnati, OH (US)

Correspondence Address: WOOD, HERRON & EVANS, LLP, 2700 CAREW TOWER, 441 VINE STREET, CINCINNATI, OH, 45202, US

(73) Assignee: NetLeaseX IP Holdings, LLC, Cincinnati, OH (US)

(21) Appl. No.: 11/061,921

(22) Filed: Feb. 18, 2005

(51) Int. Cl. G06Q 99/00

(52) U.S. Cl. 705/1

(57) ABSTRACT

An apparatus, method and program product to provide an online marketplace to enable real estate sellers, passive, real estate investors, and master lessees and sponsors of TIC transactions to contract regarding fractional and other real estate interests, including TIC property, remainder interest, estate for years, subordinated fee interest and sale-leaseback scenarios. Property investment, financing, management, TIC-owned and TIC sponsor profiles are automatically matched to queries to determine potential contracting entities. Transactions initially focus on real estate-secured income streams, rather than property addresses and specifics, to allow sellers and buyers and master lessees to contract without initial regard to actual property location or ability to independently circle funds.

### CROSS-REFERENCE TO RELATED APPLICATIONS

This application is related to U.S. patent application Ser. No. ______, entitled ONLINE TRANSACTION SYSTEM FOR FRACTIONAL INTERESTS IN REAL ESTATE, filed on even date herewith by Ronald B. Zimmerman and Jack A. Donenfeld, and is fully incorporated by reference herein.

### FIELD OF THE INVENTION

The invention relates generally to computers and computer software, and more particularly, to conducting online real estate transactions.

### BACKGROUND OF THE INVENTION

With the volatility in the stock market and historically low yields in the fixed income market, many investors have come to view real estate as a safe haven for their investment assets. The real estate market offers less volatility, higher predictable yields than fixed income investments and dividend paying stocks, in addition to the possibility of long term capital gains.

The appeal of real estate is further enhanced by tax incentives, such as legislation permitting tax deferred property exchanges. Section 1031 of the Internal Revenue Code permits a real estate investor to defer the taxes on the capital gain realized when investment real estate is sold, if the sales proceeds are reinvested in other investment real estate having both value and debt of equal to or greater than the value and debt of the property that is sold.

Real estate is popular as an investment not only for the foregoing reasons, but also because it gives investors an opportunity to determine the extent to which they want to be involved in the day to day operation of properties they purchase. The extent of such involvement may determine their return on investment. Even investors who desire to have a completely passive investment can “net lease” properties and shift all management responsibilities to another party who sometimes is referred to as a “master lessee.” Further, through the purchase of tenants in common (“TIC”) interests, investors can obtain the benefit of secure cash flows that are more available from investing in larger properties. In arrangements of this sort, each of the TIC investors purchases an undivided, fractional fee in an acquired investment property in proportion to the amount of his or her investment. The TIC investors typically enter into an agreement providing for exercise of joint control over the property and for sharing the maintenance and management costs on a pro-rated basis, based on the TIC investor's respective ownership interest in the acquired property.

Despite the appeal of TIC arrangements, their potential has not been fully exploited because of the widespread belief that, after division of a fee interest into fractional shares, the pieces generally have less value than the whole and are difficult, expensive and time-consuming to sell. There are several reasons for this. After whole ownership is divided into TIC interests, generally they are deemed to be securities under law, and their purchase and sale thereafter are regulated by state and Federal securities laws. Thus, TIC interests cannot be sold by traditional real estate brokers or through classified advertising and other traditional real estate marketing avenues.

Because TIC investors own securities, they have had a difficult time selling their investments. Their sales opportunities have generally been limited to reselling their TIC investments back (a) to the sponsors of their respective TIC investments, (b) to one of their co-TIC investors, or (c) to one of a limited number of financially savvy investors. With so few choices, TIC investors, if they desire to sell their investments, receive prices that are less than they would otherwise receive in an efficient and transparent marketplace as proposed in the invention. Therefore, the marketplace has been undesirable to investors seeking the highest returns on their investment capital. Traditionally, TIC sponsors have sold TIC interests through licensed securities broker-dealers, which have charged sales commissions that, ultimately, have been borne by the TIC interest purchasers who pay higher prices than they would pay for the TIC interests in the absence of the sales commissions.

For at least the above reasons, a more efficient and profitable manner of transacting real estate is needed.

### SUMMARY OF THE INVENTION

The invention addresses these and other problems associated with the prior art by providing an online marketplace to enable real estate sellers, passive real estate investors, master lessees and sponsors of TIC transactions to contract regarding fractional and other real estate interests, including TIC properties, remainder interests, estate for years, subordinated fee interests and sale-leaseback scenarios. To this end, a system of the present invention maintains a memory configured to store the profiles typically associated with TIC sponsors, passive real estate investors, real estate sellers/owners and/or master lessees. Each profile may include a number of parameters. For instance, a profile may include a purchase price, a general location, a capitalization rate, a lease term, a property type, a credit rating, a credit enhancement (if offered and/or a future interest, if applicable). The parameters of the profile are matched to a user's query. The parameters may be mathematically weighted for the purpose of determining a relevancy score, which is reported to the user as part of the matched results.

The invention includes a system for communicating certain parameters of a profile among the users of the invention. However, the address of the property involved may not be communicated to the user in response to the match. This feature underscores one focus of an embodiment of the invention: developing a marketplace for real estate-secured income streams, rather than a marketplace for specific real estate assets. This feature encourages investors to initiate transactions based solely on a selected property type, rate of return, general geographic location and other criteria meeting their financial goals, without becoming unduly fixated on a particular property and associated location at the initial stage. This feature thus brings into consideration by the user a broader range of real estate related opportunities than otherwise available having the potential to meet the user's needs.

To effectuate a marketplace for real estate-secured income streams as embodied in the invention, the user may post a non-binding, indication of interest to purchase a specified interest in the property based on the profile parameter(s). The address may later be communicated to the user and due diligence information will be shared among users to further a transaction process. A fee may be charged for the service of bringing the transacting parties together.

Aspects of the present invention accommodate and enhance nearly any type of real estate transaction by, in part, providing a large, dynamic customer base. Typical real estate transactions may include a TIC interest, a subordinated fee interest, an estate for years, a remainder interest and/or other fractional interests. The TIC interest may include an existing or a newly-originated TIC. Still another transaction may include an entire (or fee simple) interest in a property.

Another aspect of the invention allows a sponsor of a TIC project, such as an apartment or office building, to post the project to system memory. Investors who wish to resell their TIC investment can select the TIC project that their TIC sponsor posted to system memory. After selecting his or her TIC project, the TIC investor can post his or her TIC investment to system memory for resale. Prospective TIC purchasers may then query the database and post an indication of interest to purchase one or more posted TIC investments.

In another aspect of the invention, a passive real estate investor can match a management profile to a property or financing profile. The investor may then post an indication of interest to purchase a particular property to system memory (e.g., to a database). Such purchase would be subject to a master lease in favor of a master lessee that the investor selects. Investors can select a master lessee based on the investor's demand for a particular “spread” on the master lease, which is the difference between the return the net operating income received by the master lessee and the agreed upon return paid to the investor. Other criteria for selecting the master lessee includes real estate experience, net worth and the level of credit enhancement offered to further secure the master lessee's performance on the master lease obligation. This feature allows a passive real estate investor who does not wish to manage a property to acquire a property, subject to a master lease to a master lessee that he or she selects. Conversely, a master lessee may access the system memory and an associated profile to locate a passive real estate investor who needs property management. A master lessee may master lease a property and guarantee a certain spread or pass through rate of return to an investor. These features additionally open up a new market for property managers, who may now work directly with potential investors seeking to layoff all or most of the associated risks of owning investment real estate.

Where desired, a profile user may be presented with comparable data relevant to competing profiles. Another display of data may include the historical sales activity regarding a TIC project and TIC sponsor. A profile user may be allowed to adjust their profile at any time according to the comparable data and/or user feedback.

Another aspect of the invention maintains a profile associated with buyers seeking to purchase as a group at least an interest in real estate. The system enables a group of investors, an “investment group”, to purchase the real estate property together, based on each of the investors posting indications of interest to purchase a certain percentage interest in a property, subject to a loan amount as determined by the user who creates the investment group. In one embodiment, the type of property desired by the group is normally not associated with fractional interests. Individual investor with self-indicated investment amounts are enabled to join with others to reach a funding threshold necessary to purchase the interest in the real estate.

Another aspect of the invention enables a user to split interests in a real estate property between a fee interest and a leasehold interest. The system then automatically matches a query with at least one of a seller and a buyer and enables the sale of the fee interest to the buyer, wherein the fee interest is subordinate to the leasehold interest.

In another aspect, an embodiment of the invention provides a system whereby a passive net lease investor can post an indication of interest to purchase a fractional fee interest with a real estate investor (i.e., the master lessee) owning a fixed, undivided fractional fee interest in the property as a co-TIC investor. At closing, one or more passive net lease investors may net lease his or her fractional interest directly to the master lessee on a triple net basis.

Aspects of the present invention thus provide users with opportunities to receive safe, steady streams of income with desired liquidity and optional management of the property. The system offers 1031 investors a number of prospective properties that they can quickly identify as their replacement properties so that they can complete their contemplated exchange transactions. Moreover, all online net lease investments are structured so that the net lease investor may not have to actively manage his or her newly acquired property.

By providing a dynamic online marketplace, the invention circumvents the conventional broker/dealer networks, thereby allowing passive real estate investors (providers of net lease financing) alone (or with other prospective co-TIC investors) to interface directly with master lessees (users of net lease financing) online. This feature allows more efficient communications and reduces transaction costs. By promoting direct transactions among online buyers, sellers, and master lessees, the system further enables high leverage financing with non-institutional funding sources by capitalizing on dealing directly with online buyers.

Among other achievements, this invention allows prospective TIC investors to purchase TIC's without the layer of hefty fees and marked-up prices associated with investors purchasing TIC's in today's marketplace. In addition, the invention addresses the liquidity problem discussed above by establishing an efficient and transparent secondary marketplace where investors can resell their TIC investments at the TIC's intrinsic, market-clearing price. In these ways, this invention provides improved transaction processes that enables real estate transactions to be made in a more efficient and more profitable manner for all involved parties.

The above and other objects and advantages of the present invention shall be made apparent from the accompanying drawings and the description thereof.

### BRIEF DESCRIPTION OF THE DRAWINGS

FIG. 1 is a block diagram of a system consistent with the invention.

FIG. 2 is a block diagram of an exemplary hardware and software environment for a computer of the system of FIG. 1.

FIG. 3 is flowchart having steps suitable for execution by the systems of FIGS. 1 and 2 for the purpose of creating and posting a profile.

FIG. 4 is a flowchart having steps suitable for execution by the systems of FIGS. 1 and 2 for posting an indication of interest using the profile of FIG. 3.

FIG. 5 is a flowchart having steps suitable for execution by the systems of FIGS. 1 and 2 for closing a real estate transaction initiated by a user posting an indication of interest as described in FIG. 4.

FIG. 6 is an exemplary browser screen showing results of a search query accomplished during the processes of FIG. 4.

FIG. 7 is flowchart having steps suitable for execution by the systems of FIGS. 1 and 2 for the purpose of creating and posting a TIC profile.

FIG. 8 is a flowchart having steps suitable for execution by the systems of FIGS. 1 and 2 for closing a TIC transaction initiated in FIG. 7.

FIG. 9 is an exemplary browser screen showing results of a search query accomplished during the processes of FIG. 8.

FIG. 10 is an exemplary browser screen displaying TIC profiles that may be accessed using a link of the screen of FIG. 9.

### DETAILED DESCRIPTION

### Hardware and Software Environment

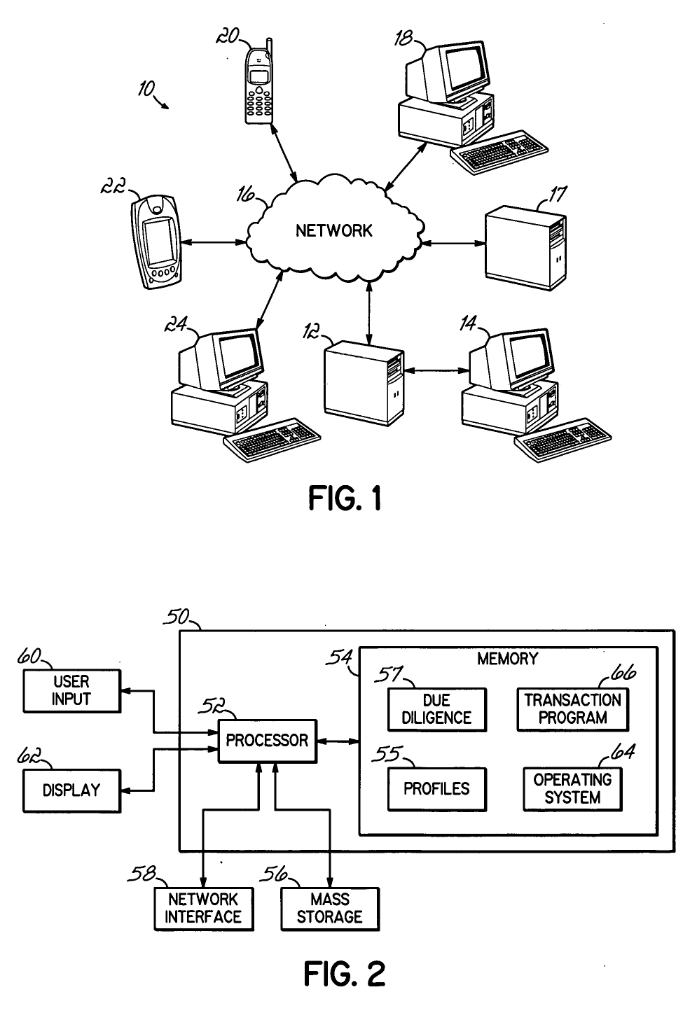

Turning to the Drawings, FIG. 1 illustrates an online real estate transaction apparatus, or system 10, providing a dynamic, virtual marketplace for real estate owner/sellers, TIC sponsors, passive real estate investors and master lessees. In one sense, the system 10 provides accessible and real time communication for managing fractional interests, such as TIC investments. By focusing on real estate-secured income streams, rather than conventional property addresses and specifics, the system 10 allows users to contract without initial regard to actual property location or ability to independently circle funds, while accommodating the broadest range of transactions, including sale-leaseback, subordinated fee investment, estate for years, reminder interest scenarios. To this end, information stored in profiles associated with property owner/sellers, passive real estate investors, TIC sponsors and master lessees are automatically matched to determine potential contracting entities.

The real estate computer system 10 includes a server 12 coupled to a system computer 14. Though shown in proximity to one another in FIG. 1, one skilled in the art will appreciate that they could alternatively be connected over a network connections, such as the Internet 16. Passive real estate investors, real estate owner/sellers, and master lessees access the server 12 via the Internet 16 or some other network using computers, servers and other electronic devices 17-24. Although only electronic devices are shown in FIG. 1, one skilled in the art will appreciate that other conventional communication practices may alternatively and/or additionally be used to communicate due diligence and other real estate information, including face-to-face meetings, postal mail and email.

FIG. 2 illustrates in another way an exemplary hardware and software environment for an apparatus 50 consistent with the invention. For the purposes of the invention, apparatus 50 may represent practically any type of computer, computer system or other programmable electronic device, including a computer 12 or any of a number of devices shown in the system 10 of FIG. 1. Each such computer may be implemented as a desktop computer, a server computer, a workstation, a portable computer, a handheld computer, an embedded controller, or another other type of single- or multi-user computer. Apparatus 50 may be coupled in a wired or wireless network 16 as shown in FIG. 1, or may be a stand-alone device in some implementations. Apparatus 50 will hereinafter also be referred to as a “computer” or “system,” although it should be appreciated the term “apparatus” may also include other suitable programmable electronic devices consistent with the invention.

Computer 50 typically includes at least one processor 52 coupled to a memory 54. Processor 52 may represent one or more processors (e.g., microprocessors), and memory 54 may represent the random access memory (RAM) devices comprising the main storage of computer 50, as well as any supplemental levels of memory (e.g., cache memories), nonvolatile or backup memories (e.g., programmable or flash memories), read-only memories (ROM), etc. Memory 54 may include a number of programs executable and data retrievable by the processor 52. For example, FIG. 1 includes transaction program code 66 and stored due diligence information pertaining to property owner/sellers and/or master lessees.

Memory 54 also includes profiles 55 comprising information relating to property owner/sellers, TIC sponsors, passive real estate investors and master lessees. More specifically, a personal profile includes information submitted by a user during registration, including a desire to receive certain promotion and informative electronic mail messages, or emails, as well as a status indicative of the user's membership to the website. Each property profile relates to a specific real estate property that a user who creates the profile owns and desires to sell, whether the user seeks a transaction involving a fractional or a whole interest or some other estate. As such, the user may post a property profile to have it searched, along with other property profiles, by potential buyers. A management profile may include parameters useful in matching the profile to a property to be master leased.

Another type of stored profile 55 includes an investment profile. An investment profile typically comprises information about creating and managing real estate investments, including those pertaining to investment groups. Investment profiles are typically created by passive real estate inventors, or investors who are not interested in managing a property. For instance, a user creating an investment profile may include a 1031 investor.

Each financing profile relates to a specific property that a user desires to have one or more passive real estate investors to purchase on his or her behalf, subject to a master lease to the user on terms posted to system memory. The user who creates a financing profile does not actually own the underlying real estate. Instead, the user who creates the financing profile is offering a specific property to net lease investors for purchase by them, subject to a master lease from the user who creates the financing profile. Conventionally purchasing the property might require the user to provide in cash twenty percent of the purchase price of the property in order to secure the remaining eighty percent in financing. Using the financing profile of an embodiment of the present invention, the user may instead take advantage of online net lease financing, or inducing an online purchaser to purchase the property on behalf of the user. For instance, an online 1031 inventor who has ten days left to make a tax-deferred exchange may buy and master lease the property to the user. This may allow the user to control the property (through the master lease) without requiring him or her to pay more than, for instance, five percent of the purchase price. Such payment is in the form of a security deposit that is provided to credit enhance the user's master lease obligation. Alternatively, such payment may be in the form of an option fee, if one is acquired. This feature may allow the user to acquire rights to four times as much real estate than otherwise possible with a fixed amount of investment capital.

A TIC project profile may include information associated with a tenants-in-common property that a user desires to market to online to passive investors. One TIC profile may include a TIC purchased through the system 10 or through a third party sponsor. The TIC sponsor may further urge potential TIC investors to access the system 10 to promote greater sales due to enhanced liquidity of TIC investments.

One skilled in the art will appreciate that the above discussed examples of profiles is not meant to be exhaustive, as the number and types of potential profiles is only limited by the number of potential real estate transactions and system functions available to users. In any case, the system 50 matches the above and other profiles to queries in order to create an online marketplace for sellers and buyers of fractional and other property interests and management companies and/or real estate investors who desire to master lease properties.

In addition, memory 54 may be considered to be or include memory storage physically located elsewhere in computer 50 (e.g., any cache memory in a processor 52), as well as any storage capacity used as a virtual memory (e.g., as stored on a mass storage device 56 or on another computer coupled to computer 50 via network 62).

Computer 50 also typically receives a number of inputs and outputs for communicating information externally. For interfacing with a user or operator, computer 50 typically includes one or more user input devices 60 (e.g., a keyboard, a mouse, a trackball, a joystick, a touchpad, and/or a microphone, among others) and a display 62 (e.g., a CRT monitor, an LCD display panel, and/or a speaker, among others). For additional storage, computer 50 may also include one or more mass storage devices 60 (e.g., a floppy or other removable disk drive), a hard disk drive, a direct access storage device (DASD), an optical drive (e.g., a CD drive, a DVD drive, etc.), and/or a tape drive, among others. Furthermore, computer 50 may include an interface with one or more networks 62 (e.g., a LAN, a WAN, a wireless network, and/or the Internet, among others) to permit the communication of information with other computers coupled to the network. It should be appreciated that computer 50 typically includes suitable analog and/or digital interfaces between processor 52 and each of components 54-62 as is well known in the art.

Computer 50 operates under the control of an operating system 64, and executes or otherwise relies upon various computer software applications, components, programs, objects, modules, databases, data structures, etc. (e.g., as represented by application 66). Moreover, various applications, components, programs, objects, modules, etc. may also execute on one or more processors in another computer coupled to computer 50 via a network 62 (e.g., in a distributed or client-server computing environment), whereby the processing required to implement the functions of a computer program may be allocated to multiple computers over a network.

In general, the routines executed to implement the embodiments of the invention, whether implemented as part of an operating system or a specific application, component, program, object, module or sequence of instructions will be referred to herein as “program code,” or simply “programs.” The program code typically comprises one or more instructions that are resident at various times in various memory and storage devices in a computer, and that, when read and executed by one or more processors in a computer, cause that computer to perform the steps necessary to execute steps or elements embodying the various aspects of the invention.

Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, magnetic tape, optical disks (e.g., CD-ROM's, DVD's, etc.), among others, and transmission type media such as digital and analog communication links.

In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Those skilled in the art will recognize that the exemplary environments illustrated in FIGS. 1 and 2 are not intended to limit the present invention. Indeed, those skilled in the art will recognize that other alternative hardware and/or software environments may be used without departing from the scope of the invention.

### Real Estate Transaction Processes

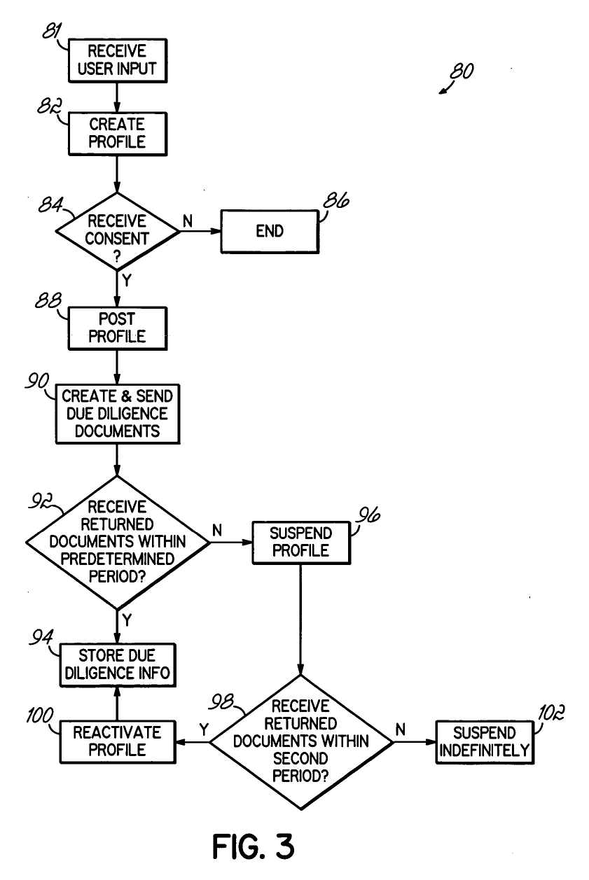

FIG. 3 is a flowchart 80 having steps suitable for execution by the systems of FIGS. 1 and 2 for the purpose of creating and posting a profile 55. At block 81 of FIG. 3, the system 10 receives user input needed to create a profile at block 82. The user may include a potential buyer, seller or master lessee, among others. Exemplary user input may include contact and financial information, particularly as that input relates to transaction goals of the user (e.g., a property sought or for sale by the user). The parameters input by a user for creating a profile 55 typically include required fields. The required fields promote uniformity and efficiency. The system 10 uses this uniformity to match profiles 55 and user queries according the input profile parameters. More particularly, the system 10 samples, weights and/or otherwise uses the required parameter fields to match the profile parameters to queries. For instance, a data field requiring input may prompt the user for a range of desired selling prices of a TIC property.

Many of the fields required at block 81 for input by the user may be automatically filled in using data previously entered by the user (e.g., using data drawn from another profile of the users). As discussed below in greater detail, other data may be provided by a third party having an interest in the user's property. For instance, a TIC sponsor may enter information regarding a TIC project into the memory 54. As such, a potential investor desiring to create a TIC owned profile for the TIC project needs to spend minimal time entering information at block 82, by virtue of most of the profile information being automatically populated.

The system 10 may verify at block 84 of FIG. 3 that the user agrees to transaction terms and conditions for using the system 10. Such terms displayed on the system website may include a description of a commission rate to be paid by the user. The commission may be based on the price of a posted property and/or the nature of a transaction facilitated by the system 10. The commission typically becomes due at the close of a successful transaction. User agreement at block 84 may comprise a user selecting in a dialog box a prompt designating acceptance of the terms.

In the case where a refusal is received at block 86, the user's profile will not post. Alternatively, at block 88, acceptance of the terms at block 84 will cause the property to post to the memory 54. The system 10 may then generate and send an email notification to the user at block 90 asking the user to provide due diligence information. If the due diligence information is received at block 92 within a predetermined time (e.g., ten days), the documents 57 will be scanned and/or stored within memory 54 at block 94. The due diligence documents 57 may ultimately be stored as PDF files posted to the web server.

If, alternatively, no due diligence documents 57 are received at block 92, then the user's profile 55 will be suspended at block 96. So long as the user's profile 55 remains suspended at block 96, the profile 55 will no longer appear in query results. Should the due diligence documents 57 be subsequently received at block 98, however, the profile 55 may be reactivated at block 100.

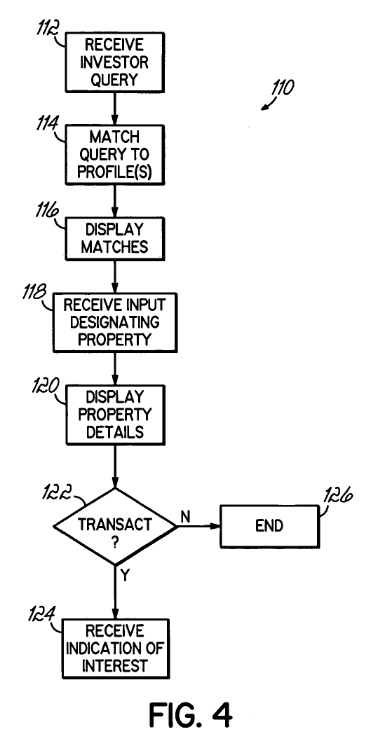

FIG. 4 is a flowchart 110 suited for execution by the systems of FIGS. 1 and 2 for posting an indication of interest. An indication of interest for purposes of this specification may include a preliminary notification and statement of good faith interest in initially proceeding with a transaction. The indication of interest may be non-binding and posted after the profile 55 of FIG. 3 is matched to a query. At block 112 of FIG. 4, a user queries the memory 54 to find a profile 55 match. A user may include, for instance, an investor desiring to purchase all or an interest in a property (e.g., a TIC interest), which would be subject of a financing or property profile created in FIG. 3. In another scenario, the user may be a master lessee looking for real estate to master lease and manage himself.

In one embodiment, the query is automatically generated from information input by an investor creating his or her own investment profile. Profiles may alternatively be matched in response to a query not yet associated with a profile (i.e., a user accessing the website for the first time). In any case, the system 10 receives the query from the user at block 112. For efficiency reasons, the criteria input by a user making a query may include required fields. The system 10 samples, weights and/or otherwise uses the required fields to match the query criteria to available profiles 55. For instance, a field required in a query may prompt the user for a range of acceptable capitalization rates.

The system 10 matches profiles 55 to the query at block 114 of FIG. 4. The matching is typically accomplished by correlating parameters of the profiles 55 to query criteria. Both the query criteria and profile data is structured and stored so that it may be readily matched. For instance, a user populating fields of a profile indicating a desire to transact in a sale-leaseback scenario may be made to enter a pass through rate. This rate may be used to match at block 114 the profile to a query having a desired pass through range into which the profile rate falls. To this end, query criteria and profile parameters may be weighted according to relative importance. For instance, a property price range may be weighted more in proportion to its relative greater importance than, for instance, a lease term. This weighting may be accomplished automatically and/or in response to user input.

The system 10 displays the search results to the user in descending order at block 116. The order may be based on a number of parameter matches, which may include a calculated relevancy score. The relevancy score may take into account weighted factors that include, for instance, a purchase price, a general location, a capitalization rate, a lease term, a credit rating and/or a credit enhancement.

The system 10 at block 118 may receive input from a user selecting a displayed property and/or other transacting option. In response to the user selection at block 118, the system 10 may display additional details of the property and/or user profile at block 120. Of note, property information displayed at block 120 may not include the specific address of the real estate property. This feature underscores a feature of the invention that develops a marketplace for real estate-secured income streams, rather than for specific properties. This feature encourages investors to initiate transactions based on property types and other criteria meeting their financial goals, without becoming initially fixated on specific properties. This feature thus brings into consideration by the user a broader range of real estate related deals having the potential to meet the user's needs.

If the user wishes to initiate a transaction at block 122 based upon the information displayed at block 120, then the user may post an indication of interest that the system 10 receives at block 124 of FIG. 4. The indication of interest may be recorded in memory 54 and ultimately communicated to a user associated with the selected real estate property, service and/or other offering.

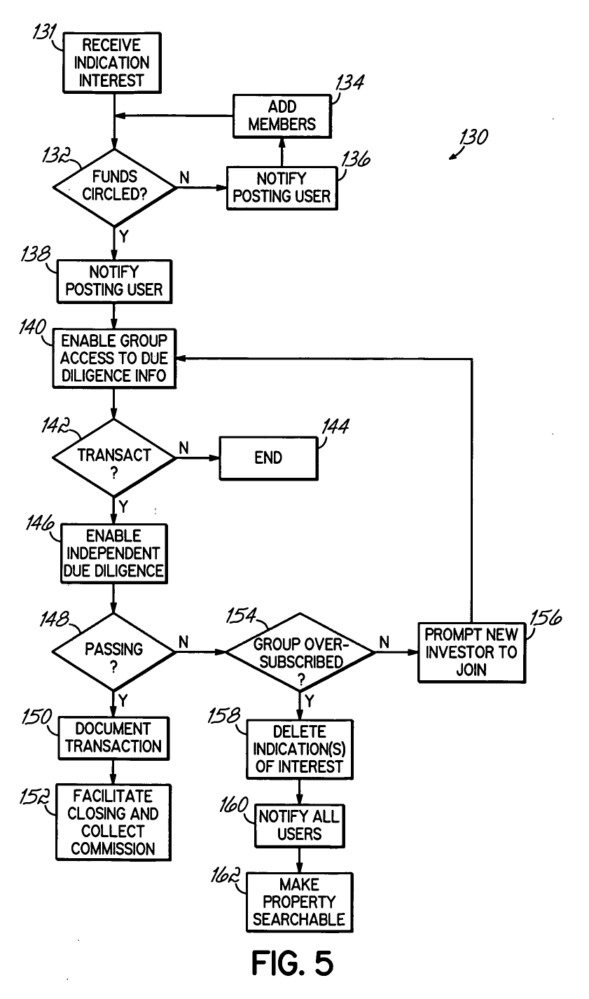

FIG. 5 is a flowchart 130 having steps executable by the systems of FIGS. 1 and 2 for closing a real estate transaction deal initiated by the indication of interest discussed in the flowchart 110 of FIG. 4. To this end, the flowchart 130 includes receiving an indication of interest at block 131. FIG. 5 more particularly is directed to an investor's purchase of a real estate property. As discussed herein, the investor may be interested in purchasing the property on their own, or as a part of an investment group facilitated by an embodiment of the invention. For purposes of this specification, property may include a partial or whole interest in a real estate property.

At block 132 of FIG. 5, the system 10 may determine if one hundred percent of the investment needed to purchase the property is present, or has been circled by the investor or a group of investors. If not, then the system 10 at block 134 may send an email or other communication to the seller who posted the property profile, informing the seller that a net lease investor has posted an indication of interest. The system 10 may additionally add the new investor who posted the indication of interest to a group seeking to acquire enough to circle the investment at block 132.

Assuming sufficient investment is present at block 132, the system 10 may send an email notification at block 138 informing the posting seller that sufficient funds have been circled to purchase the property. The system 10 further enables all members of an investment group at block 140 (and a master lessee, if appropriate) to review due diligence documents 57. The users may review the due diligence documents 57 in real time on a private transactions page.

If there is no desire to transact at block 142 after reviewing the due diligence documents 57, then the transaction will end at block 144. If, however, the members in the investment group and the master lessee (if one is selected) alternatively decide at block 142 to transact, then the system 10 will allow the users in the investment group and/or master lessee to conduct their own independent due diligence on the property. Such due diligence may include providing additional information on the property, including the address of the property to the users at block 146.

If the property and/or proposed transaction (e.g., a leaseback) passes due diligence at block 148, then the system 10 may generate and deliver at block 150 purchase contracts and/or letters of intent for delivery to the users. While deal closings may occur outside of the networked system 10 environment, the system 10 may nonetheless facilitate the exchange of contractual and other paperwork and information needed to close the deal at block 152 of FIG. 5. Such deal closings may include collection of commissions for transaction facilitation services provided by the system 10.

If the property or proposed transaction fails to pass due diligence at block 148 to the satisfaction of all members of the investment group, then the system 10 may determine at block 154 whether the investment group is over subscribed. An over subscribed status is assigned where there are potential investors waiting, on standby, to participate in an investment group. These potential buyers may be added as needed to the investment group to help further the transaction onto closing. For instance, the system 10 may send an email notification at block 156 to a net lease investor who has posted the highest indication of interest on standby to join the investment group. The system 10 may then allow the new user, previously on standby and added at block 156, to review the due diligence documents back at block 140.

If the investment group is not over subscribed at block 154, then the system 10 at block 158 may delete or otherwise deactivate indications of interest for those investors who wish to drop out of the investment group. The system 10 at block 160 may then notify all users watching via a watch list website feature of the property's change of status. That is, the users may be notified that the property that the winning investment group has been disbanded and that the property is again available for acquisition. Notification at block 160 is typically accomplished using email. The system 10 at block 162 configures the property and/or potential partner profile to again be searchable. As such, the system 10 may match the property against a next highest match of an indication of interest, as discussed at block 112 of FIG. 4.

While the embodiment shown in FIG. 5 is directed particularly to a transaction for a group of investors interested in purchasing or leasing a property, a group for purposes of the specification may include a single member. As such, a single individual may transact in a manner similar to the processes shown in FIG. 5;

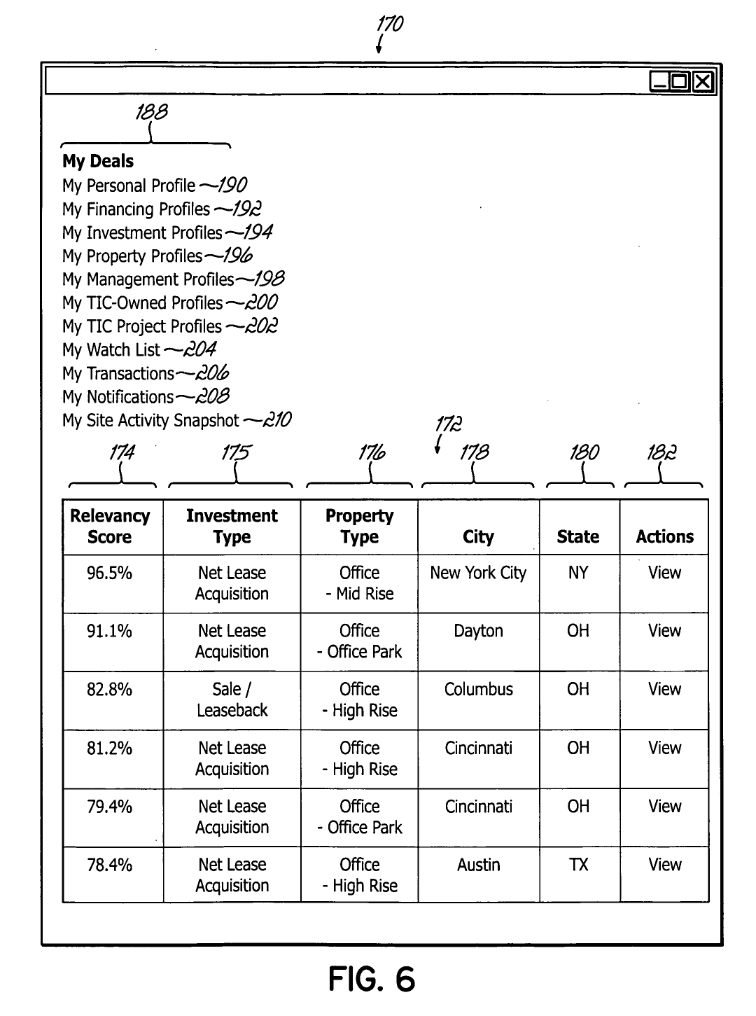

FIG. 6 shows an exemplary display screen 170 showing tabled results 172 of a search query, such as the results displayed during the processes of FIG. 4. The initial tier results 172 were generated for a financing profile. The display screen 170 presents the search results 172 to the user in descending order. The order may be based on a number of parameter matches, which may include a calculated relevancy score, as shown in column 174. The relevancy score 174 may take into account weighted factors that include, for instance, a purchase price range, a property type, a general location, a capitalization rate, a lease term, a credit rating and/or a credit enhancement. The higher the relevancy score, the closer the searched results match the parameters of the profile, or query. For instance, a 100% relevancy score would indicate an exact match.

Factors and other information displayed on the screen 170 include the type of investment, city and state of the property 175, 176, 178 and 180, respectively. A user selecting “View” in column 182 may link to a new browser screen displaying more particular information regarding a selected property (e.g., a transactions page tracking pending transactions relevant to the selected property).

In addition to alternative financing profiles 192, the exemplary interface screen 170 includes a column 188 having additional profiles 190, 194, 196, 198, 200 and 202 associated with the user and their dealings. A personal profile 190 may include membership and other information pertaining to a user's account. Each financing profile 192 relates to a specific property that a user desires to have one or more passive real estate investors to purchase on his or her behalf subject to a master lease to the user on terms posted to system memory. An investment profile 194 may include information about creating and managing real estate investments, including those pertaining to investment groups. Each property profile 196 relates to a specific real estate property that a user who creates the profile owns and desires to sell, whether the users seeks a transaction involving a fractional or a whole interest or some other estate. A management profile 198 includes information pertaining to a user seeking to master lease (and option, if one is acquired) a property matching the criteria posted to system memory. A TIC owned profile 200 may include information associated with a TIC property that a user desires to market to online, passive investors. A TIC project profile 202 may include a TIC project posted by a sponsor to enable its investors to identify their respective TIC project from a list, thus streamlining the resale of TIC investments.

In addition to the profile options 190-202, the column 188 of the screen 170 also presents the user with links to files useful in monitoring ongoing web activities. For instance, a watch list 204 provides information about posted properties of interest to the user. A transactions page 206 enables users to track their pending transactions, including reviewing any due diligence documents that have been posted to system memory.

A notification page 208 keeps the user apprized of any email notifications, and a site activity snapshot 210 provide the user with a quick overview of all activities taken by the user and parties interested in the user's property or proposals. A site activity snapshot is a quantitative online feedback mechanism that enables a user to review, on a real-time basis, (a) a break-down of the total number of profiles posted to system memory, number of transactions consummated and currently pending, (b) number of indications of interest posted to system memory, (c) number of times that the user has been selected as master lessee, (d) number of times that the user has backed out of a winning investment group, where the user did not purchase another property, and (e) number of times the user declined offer to master lease a property, as proposed by a net lease investor.

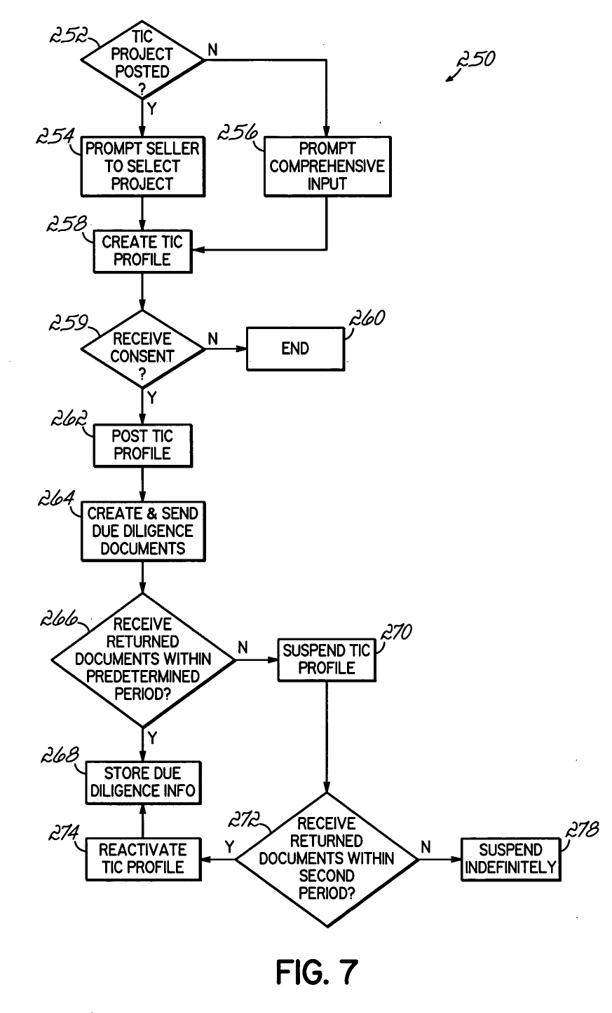

FIG. 7 is flowchart 250 having steps suitable for execution by the systems of FIGS. 1 and 2 for the purpose of creating and posting a TIC profile. In creating a TIC profile, the system 10 may first determine at block 252 whether a TIC sponsor has previously posted a project. Such an existing posting may permit certain economies on behalf of a TIC seller wishing to create a TIC profile. Namely, information regarding a TIC project may be entered into memory 54 by the TIC project sponsor. This information may be automatically retrieved when a seller selects an applicable TIC project at block 254. As such, a potential seller desiring to create a TIC owned profile for the sponsor's TIC project needs to spend minimal time entering information at block 258 to create a profile, by virtue of most of the profile information being automatically populated by information retrieved from memory 54.

Where no TIC project has alternatively been posted at block 252, then the system 10 may prompt at block 256 the seller to enter all necessary information to create the TIC profile at block 258. Such information may include contact and financial information, particularly as that user input relates to transaction goals of the TIC seller. The parameters input by the TIC seller for creating a profile include required fields to promote uniformity and efficiency. The system 10 uses this uniformity to match TIC profiles to user queries, as discussed herein.

The system 10 may verify at block 259 of FIG. 7 that the user agrees to transaction terms and conditions for using the system 10. Such terms displayed on the system website may include a description of a commission rate to be paid by the user. The commission may be based on the price of a posted TIC property and/or the nature of a transaction facilitated by the system 10. The commission typically becomes due at the close of a successful transaction. User agreement at block 259 may comprise a user selecting in a dialog box a prompt designating acceptance of the terms.

In the case where a refusal is received at block 260, the TIC seller's profile will not post. Alternatively, at block 262, acceptance of the terms will cause the TIC profile to post to the memory 54. The system 10 may then generate and send an email notification to the user at block 264 asking the user to provide due diligence information. If the due diligence information is received at block 266 within a predetermined time, the documents 57 will be scanned and/or stored within memory 54 at block 268. The due diligence documents 57 may ultimately be stored as PDF files posted to the web server.

If, alternatively, no due diligence documents 57 are received at block 266, then the TIC seller's profile 55 will be suspended at block 270. So long as the user's profile 55 remains suspended at block 270, the profile 55 will no longer appear in query results. Should the due diligence documents 57 be subsequently received at block 272, however, the profile 55 may be reactivated at block 24.

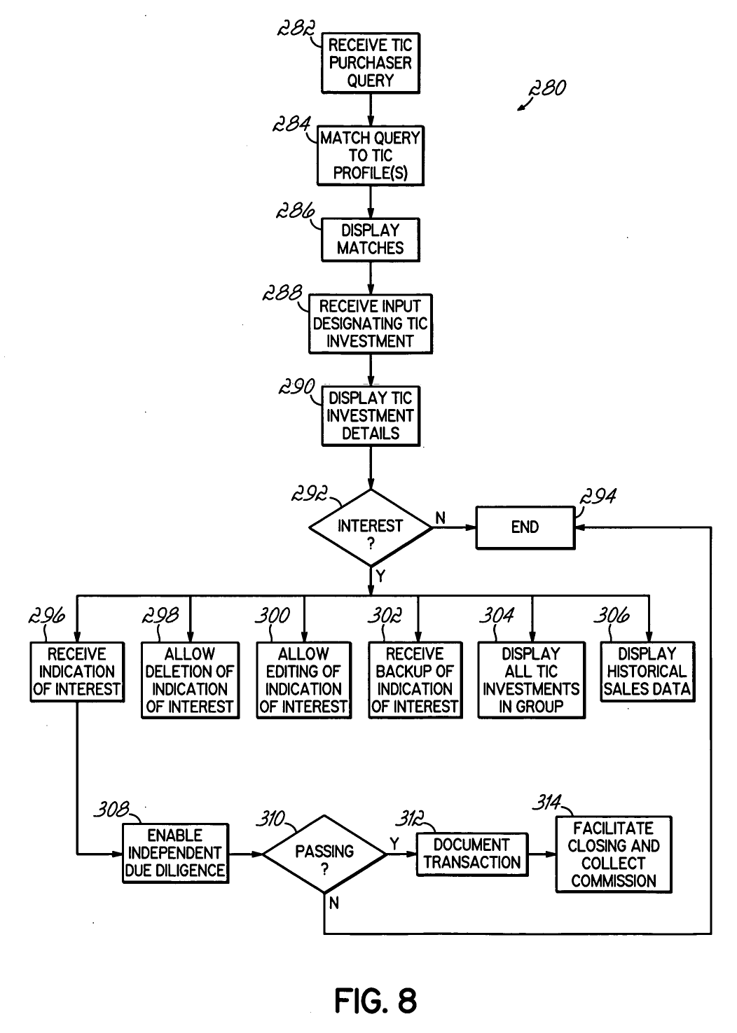

FIG. 8 is a flowchart 280 having steps suitable for execution by the systems of FIGS. 1 and 2 for closing a TIC transaction initiated in FIG. 7. At block 282 of FIG. 8, a TIC purchaser queries the memory 54 to find an investment profile match. The system 10 samples, weights and/or otherwise matches at block 284 the query criteria to available investment profiles. The system 10 displays the search results to the user in descending order at block 286.

The system 10 at block 288 may receive input from the TIC purchaser selecting a displayed TIC investment. In response to the TIC purchaser selection at block 288, the system 10 may display additional details relating to the TIC investment at block 290, including the specific address of the TIC property.

If the TIC purchaser exhibits further interest at block 292 based upon the information displayed at block 290, then the TIC purchaser may choose from a number of options designed to satisfy the purchaser's needs. For instance, the TIC purchaser may delete or edit an existing indication of interest at blocks 298 or 300, respectively. The purchaser may alternatively post a backup indication of interest at block 302, display all group TIC investments at block 304, or display historical sales data pertaining to another TIC investment in the TIC project at block 306. Where a TIC purchaser has yet to post an indication of interest, the system 10 may receive one from the purchaser at block 296. The indication of interest may be recorded in memory 54 and ultimately communicated to a TIC seller associated with the selected TIC investment.

In response to a received indication of interest, the system at block 308 will allow the TIC potential purchaser to conduct his or her own independent due diligence on the TIC property. If the TIC property passes due diligence at block 310, then the system 10 may generate and deliver at block 312 purchase contracts and/or letters of intent for delivery to the TIC users. While deal closings may occur outside of the networked system 1 0 environment, the system 10 may nonetheless facilitate the exchange of contractual and other paperwork and information needed to close the deal at block 314 of FIG. 8. Such deal closings may include collection of commissions for transaction facilitation services provided by the system 10.

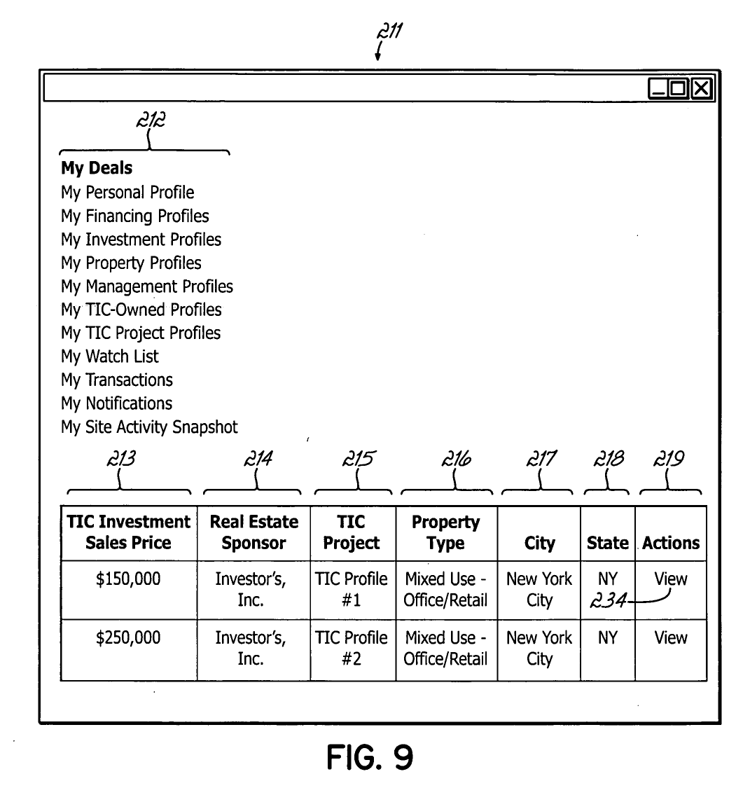

FIG. 9 is an exemplary browser screen 211 showing results of a search query accomplished during the processes of FIG. 8. The browser screen 211 more particularly shows results that may be displayed as matches at block 284 of FIG. 8 in response to a TIC purchaser query. In addition to links to desired profiles and account interfaces in column 212, FIG. 9 includes at columns 213-218 TIC investment information relating to sales price, sponsor, project name, type and general location. Selection of a “View” link 234 in column 219 will prompt the display of more particular information relating to the selected TIC investment.

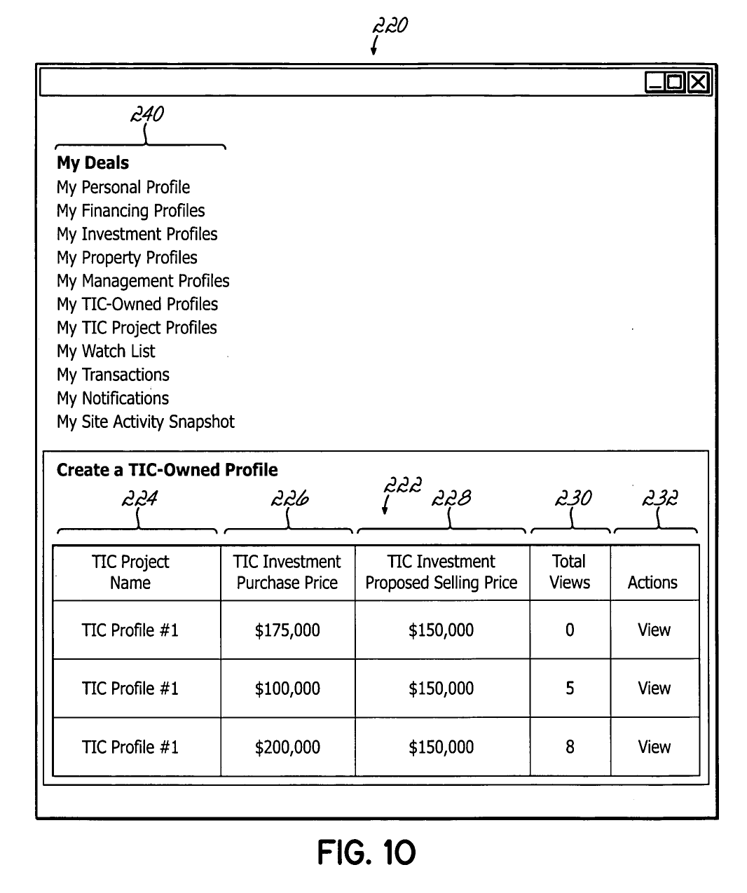

FIG. 10 shows a browser screen 220 displaying TIC profiles such that may be accessed using a link 234 of the screen 211 of FIG. 9. The screen 220 includes a table 222 of data that includes a column of projects 224. Column 226 includes prices paid by the user to purchase the TIC property, and column 228 includes the current asking price. The total views column 230 shows the number of times the site has been accessed by other users. A user selecting “View” in column 232 may link to a new browser screen displaying more particular information regarding a selected TIC property, e.g., a transactions page tracking pending transactions relevant to the selected TIC property. The screen 220 of FIG. 10 further includes links to other profiles and account interfaces in column 240.

While the above-discussed screen 220 may thus be generated to display search results for a TIC investor, one skilled in the art will appreciate that other embodiments of the invention facilitate other transaction users and types, including subordinated land sale leaseback transactions. In such a scenario, a user that wants to monetize their real estate equities while retaining control of the properties posts a property profile indicating a desire to participate in a land sale leaseback. The user then bifurcates the ownership of his or her property by selling the ground underneath their building to a passive, net lease real estate investor, while retaining ownership of the building itself.

The real estate investor who purchases the owner's ground agrees to subordinate his or her acquired fee interest to a third party lender. The third party lender makes a loan to the owner of the real estate that will be secured by a collateral pledge of the owner's retained improvements. Because the net lease investor who purchases the ground agrees to subordinate his or her fee interest to that lender, the lender effectively will have a first mortgage on the owner's property. At closing, the owner agrees to leaseback the ground from the net lease real estate investor on a triple net basis (commonly referred to as a ground lease). This feature allows very high level of leveraged financing. For example, if the owner sells a subordinated fee interest to a net lease investor for twenty-five percent of the total value of the owner's property, and the amount of the security deposit paid to the subordinated fee interest investor is ten percent of the ground purchase price, the owner effectively achieves ninety-seven point five percent loan to value financing.

In another aspect, the system 10 may accommodate transactions relating to remainder interests. For net lease investors posting an investment profile 55 and who are willing to forego cash flow in return for a locked in appreciation rate over a given holding period, a remainder interest in real property may be advantageous. By making such an investment, the investor's interest in his replacement property would not vest for a negotiable period of time (e.g., ten years). Thus, until the ten years after the date of acquisition, the estate seller can either retain the right to collect the rental income generated from the investor's selected replacement property, or sell and master leaseback the ten year leasehold interest (also known as an estate for years) to another investor.

In a master lessee participation investment structure, passive investors may use the system 10 to post an indication of interest to purchase a fractional fee interest, with master lessee owning a fixed, undivided fractional fee interest. At closing, one or more passive net lease investors would net lease their fractional fee interest directly to the master lessee on a triple net basis. By using net lease financing, as a real estate investor, the investor can control a property as if they owned it and receive the benefit of all or some of the future appreciation. As such, real estate investors and corporate end users have an opportunity to promote their real estate financing proposals to a dynamic community of passive net lease investors.

While the present invention has been illustrated by a description of various embodiments and while these embodiments have been described in considerable detail, it is not the intention of the applicants to restrict, or in any way limit, the scope of the appended claims to such detail. For instance, any of the steps of the above exemplary flowcharts may be deleted, augmented, made to be simultaneous with another or be otherwise altered in accordance with the principles of the present invention. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A computer-implemented method of brokering a real estate transaction, the method comprising:
maintaining a database configured to store a plurality of profiles associated with respective properties, each profile comprising a plurality of parameters associated with a respective property;
matching the parameters of a profile to a user query associated with a user;
communicating over a network at least one parameter of the profile to the user, wherein an address of the property is not communicated to the user; and
in response to communicating the at least one parameter, not including the address, receiving an indication of interest from the user.

2. The method of claim 1, further comprising subsequently communicating the address to the user.

3. The method of claim 1, further comprising enabling at least one of the user and a representative of the property to initiate a real estate transaction involving the property.

4. The method of claim 1, further comprising charging a fee to at least one of a representative associated with the profile and the user.

5. The method of claim 1, further comprising receiving due diligence information from at least one of a representative associated with the profile and the user.

6. The method of claim I, further comprising retrieving the user query from a stored user profile.

7. The method of claim 1, wherein matching the parameters includes matching at least one parameter selected from a group consisting of: a purchase price, a general location, a capitalization rate, a property type, a lease term, a credit rating and a credit enhancement.

8. The method of claim 1, further comprising mathematically weighting the parameters for use in determining a relevancy score.

9. The method of claim 1, further comprising creating a user profile associated with the user.

10. The method of claim 1, wherein the real estate transaction includes at least one of: a tenancy-in-common, a net lease arrangement, a master lease, a fee simple, a subordinated fee, an estate for years, a remainder and another fractional interest.

11. The method of claim 10, wherein the tenancy-in-common includes at least one of an existing and a new tenancy-in-common.

12. A computer-implemented method of brokering a real estate transaction, the method comprising:
maintaining a database storing a plurality of profiles associated with prospective property managers, sellers and purchasers;
automatically matching a management profile to at least one of an investment profile and a property seller profile; and
communicating over a network information indicative of the match to at least one of the prospective managers, sellers and purchasers.

13. The method of claim 12, further comprising configuring at least one profile of the plurality of profiles to include information indicative of a desire to participate in a lease scenario.

14. The method of claim 13, further comprising configuring the management profile to include an indication of a desire to lease a property.

15. The method of claim 13, further comprising configuring the at least one profile of the plurality of profiles to include information indicative of a desired pass-through rate.

16. The method of claim 12, further comprising selecting a master lessee based on upon at least one of the following: management criteria, net worth, required from in terms of options to make a purchase, and a security deposit amount that the master lessee will post in order to enhance the master lessee obligation.

17. A computer-implemented method of brokering a real estate transaction, the method comprising:
maintaining a database having profiles associated with a plurality of purchasers seeking to purchase an interest in real estate;
identifying a real estate property for sale, and
automatically creating a group of purchasers from the plurality of purchasers having funds sufficient to purchase the real estate property.

18. The method of claim 17, further comprising enabling the group to purchase the real estate property.

19. The method of claim 17, wherein posting the real estate property further includes configuring the property includes at least one of a tenancy-in-common, a subordinated fee, an estate for years, a remainder and another fractional interest.

20. The method of claim 17, further comprising generating an indication of interest associated with the group when funds available to the group reach a threshold level.
